(19) United States
(12) Patent Application Publication
(10) Pub. No.: US 2026/0304299 A1
(43) Pub. Date: Oct. 1, 2026

(54) METHODS, ARCHITECTURES, APPARATUSES AND SYSTEMS FOR HANDLING AMBIENT INTERNET OF THINGS (AIoT) COMMAND PROCEDURE IN A NETWORK

(71) Applicant: InterDigital Patent Holdings, Inc., Wilmington, DE (US)

(72) Inventors: Guanzhou Wang, Brossard (CA); Anuj Sethi, Ottawa (CA); Michael Starsinic, Newtown, PA (US); Mohamad Kenan Al-Hares, Canterbury (GB); Alec Brusilovsky, Downingtown, PA (US); Martino Freda, Laval (CA)

(21) Appl. No.: 19/092,223

(22) Filed: Mar. 27, 2025

(51) Int. Cl. H04W 48/16; G16Y 10/75; G16Y 20/20; G16Y 40/35; H04W 64/00

(52) U.S. Cl. CPC H04W 48/16; G16Y 10/75; G16Y 20/20; G16Y 40/35; H04W 64/003

(57) ABSTRACT

Procedures, methods, architectures, apparatuses, systems, devices, and computer program products for handling ambient internet of things (AIoT) command procedures in a network, such as the 5G core network (5GC), are described. One method may include receiving a first command request associated with multiple target AIoT devices, sending an inventory request to a RAN node, receiving device inventory response(s), sending second command requests targeted for a respective target AIoT device from the multiple target AIoT devices, receiving a plurality of command responses each respectively associated with the respective target AIoT device, and sending a command report comprising an aggregation of the command responses and indicating a respective identifier associated with the multiple target AIoT devices from which a command response was received.

### FIELD

Example embodiments described in the present disclosure are generally directed to the fields of communications, software and encoding, including, for example, to methods, architectures, apparatuses, systems related to handling ambient internet of things (AIoT) command procedures in a network, such as the 5G core network (5GC).

### BACKGROUND

Ambient internet of things (AIoT) devices refer to a new class of internet of things (IoT) devices that are characterized by low power consumption, low cost, flexibility, interoperability, and/or scalability. AIoT devices are often powered by harvesting energy from the environment, such as from radio waves, electric fields, light, heat and/or motion, etc. AoIT devices may be configured for minimal energy usage to allow operation for extended periods on the harvested energy.

### SUMMARY

An embodiment may be directed to a network element including circuitry such as a processor and/or transceiver. The network element may be configured to receive a first command request associated with multiple target ambient internet of things (AIoT) devices, send an inventory request to a radio access network node, and receive one or more device inventory responses. Each of the device inventory responses may be associated with one of the target ambient internet of things (AIoT) devices, and/or each of the device inventory responses may indicate an identifier associated with a target ambient internet of things (AIoT) device from which the device inventory response is received. Based on the device inventory responses, the network element may be configured to send a plurality of second command requests, where each of the second command requests is targeted for a respective target ambient internet of things (AIoT) device from the multiple target ambient internet of things (AIoT) devices, and where each of the second command requests indicates the respective identifier associated with the target ambient internet of things (AIoT) device from which the device inventory response is received. The network element may be configured to receive a plurality of command responses, where each of the command responses is respectively associated with the respective target ambient internet of things (AIoT) device from the multiple target ambient internet of things (AIoT) devices. The network element may be configured to send a command report comprising an aggregation of the command responses, where the command report indicates a respective identifier associated with the multiple target ambient internet of things (AIoT) devices from which a command response was received.

An embodiment may include a method, implemented by a network element. The method may include receiving a first command request associated with multiple target ambient internet of things (AIoT) devices, sending an inventory request to a radio access network node, and receiving one or more device inventory responses. Each of the device inventory responses may be associated with one of the target ambient internet of things (AIoT) devices, and/or each of the device inventory responses may indicate an identifier associated with a target ambient internet of things (AIoT) device from which the device inventory response is received. Based on the device inventory responses, the method may include sending a plurality of second command requests, where each of the second command requests is targeted for a respective target ambient internet of things (AIoT) device from the multiple target ambient internet of things (AIoT) devices, and where each of the second command requests indicates the respective identifier associated with the target ambient internet of things (AIoT) device from which the device inventory response is received. The method may include receiving a plurality of command responses, where each of the command responses is respectively associated with the respective target ambient internet of things (AIoT) device from the multiple target ambient internet of things (AIoT) devices. The method may include sending a command report comprising an aggregation of the command responses, where the command report indicates a respective identifier associated with the multiple target ambient internet of things (AIoT) devices from which a command response was received.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example AIoT system architecture, according to some embodiments;

FIG. 3 illustrates another example AIoT system architecture, according to some embodiments;

FIG. 4 illustrates a signaling diagram for an AIoT inventory procedure, according to some embodiments;

FIG. 5 illustrates a signaling diagram for an AIoT command procedure, according to some embodiments;

FIG. 6 illustrates a signaling diagram for a transformed AIoT command procedure after an inventory procedure, according to some embodiments; and

FIG. 7 illustrates a flow diagram of a method, according to some embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

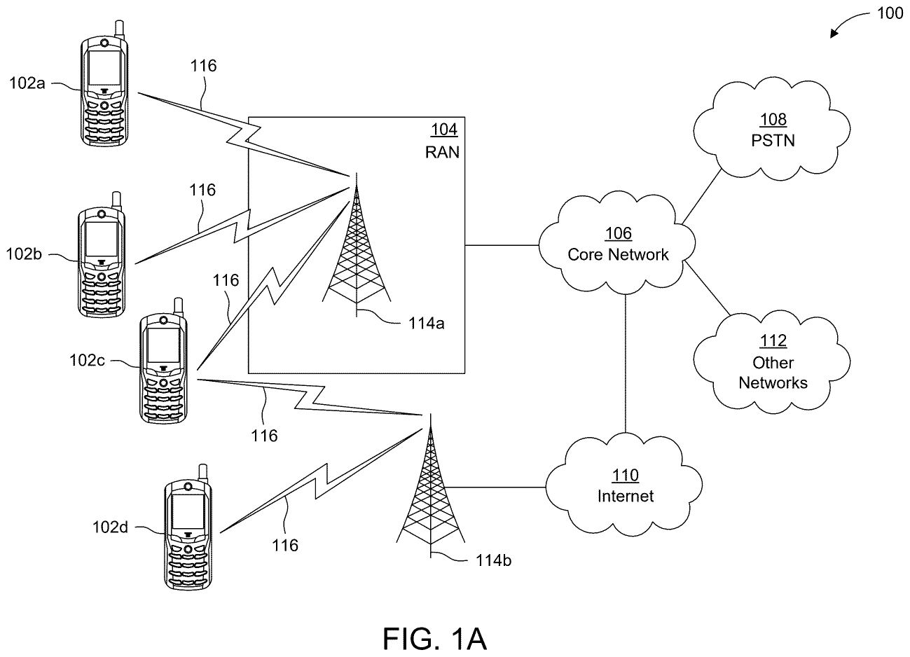

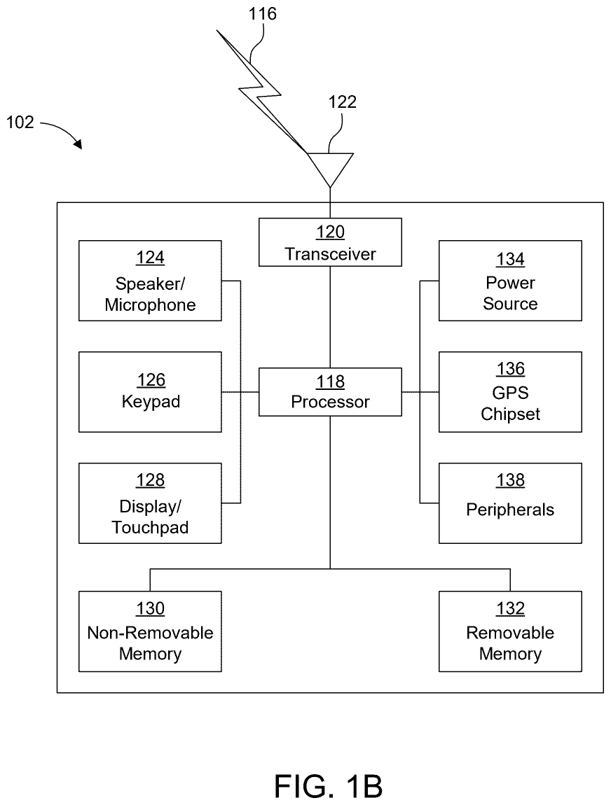

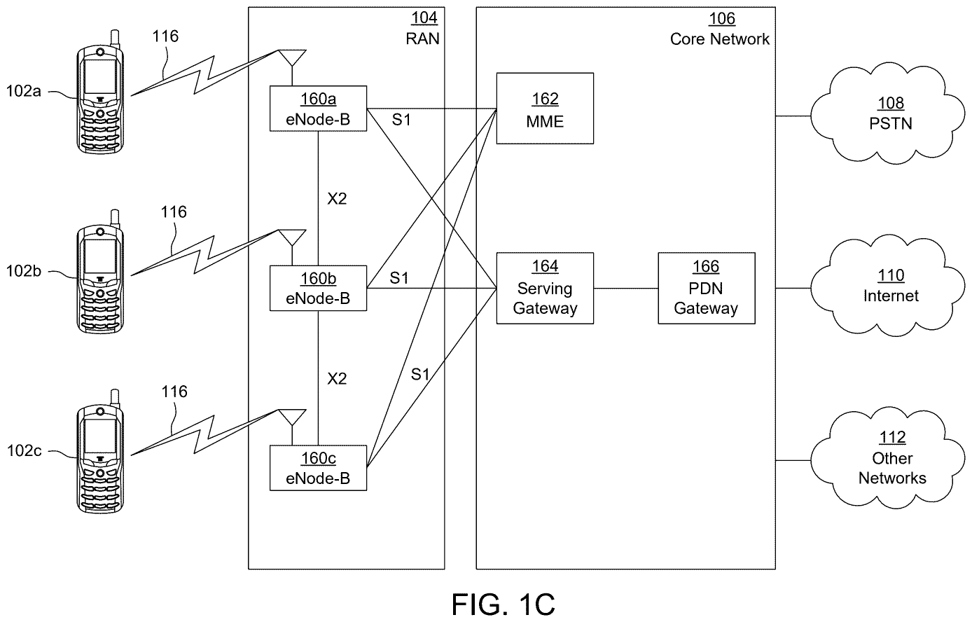

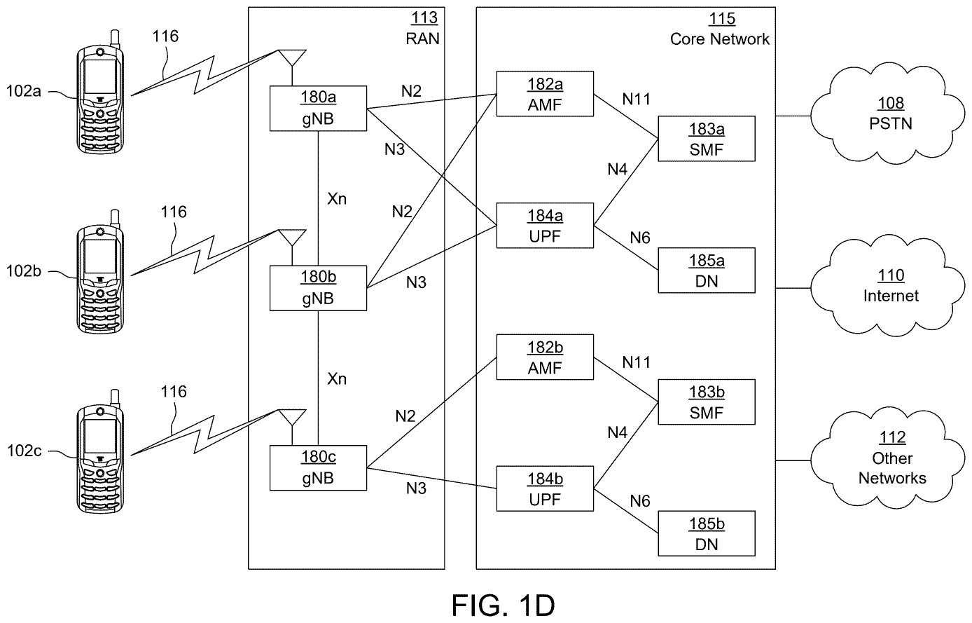

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d, or any other WTRU mentioned or described herein, may be interchangeably referred to as a UE or vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Embodiments disclosed herein are representative and do not limit the applicability of the apparatus, procedures, functions and/or methods to any particular wireless technology, any particular communication technology and/or other technologies. The term network in this disclosure may generally refer to one or more base stations or gNBs or other network entity which in turn may be associated with one or more Transmission/Reception Points (TRPs), or to any other node in the radio access network.

It is noted that, throughout example embodiments described herein, the terms “base station”, “seving base station”, “RAN,” “RAN node,” “Access Network,” “NG-RAN,” “gNodeB,” and/or “gNB” may be used interchangeably to designate any network element such as, e.g., a network element acting as a serving base station. It should be understood that embodiments described herein are not limited to gNBs and are applicable to any other types of base stations.

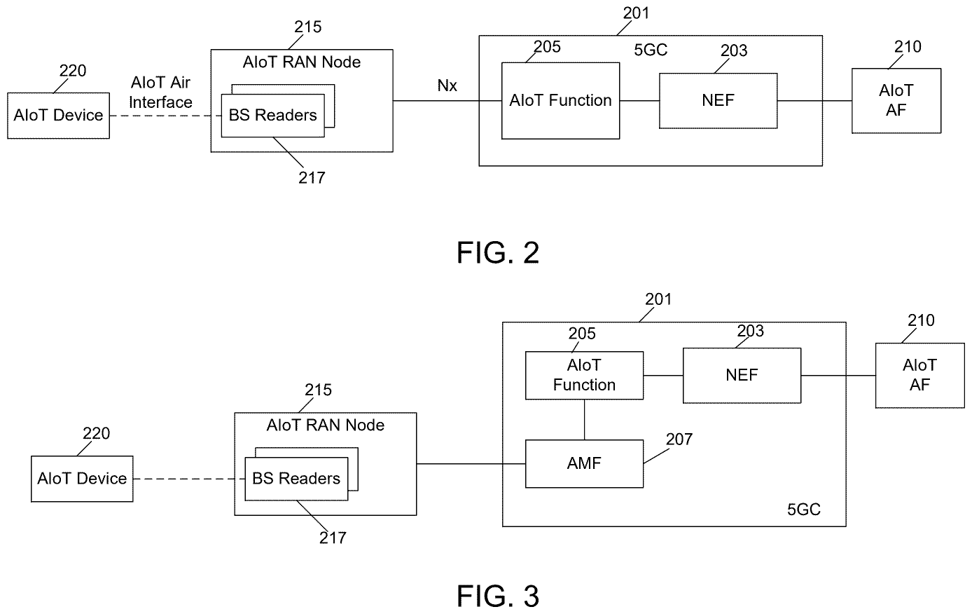

In the following, example system architectures (e.g., 5CG architecture) for supporting AIoT services is discussed. An AloTF is a new network function or node that has been introduced in 5GC to enable AIoT services, such as Inventory, Command, etc. FIG. 1 and FIG. 2 illustrate example network architectures of a 5GC 201 with an ambient IoT Function (AIoTF) 205 enabling AIoT services. FIG. 1 illustrates an example AIoT system architecture with a Direct interface between AIoT RAN 215 and AIoTF 205. FIG. 2 illustrates an example AIoT system architecture with an indirect interface (e.g., via AMF) between AIoT RAN 215 and AIoTF 205.

In certain embodiments, an AIoTF 205 may receive and handle AIoT service requests from AIoT Application Function(s) (AF) 210. The requests may be sent from the AIoT AF 210 to the AIoTF 205 via a network exposure function (NEF) 203. For examples, the AIoTF 205 may locate the AIoT RAN node 215 or BS Readers 217 that can serve the target AIoT device(s) 220 and forward the service requests to the AIoT RAN node 215 or BS Readers 217. The AIoTF 205 may provide AIoT RAN node 215 with additional assistance information that may help AIoT RAN node 215 or BS Readers 217 better perform AIoT service procedures. The AIoTF 205 may provide AIoT service report based on the responses, from the AIoT device(s) 220 to the AIoT AF 210, etc. In the example of FIG. 1, AIoTF 205 has direct interface to AIoT RAN Node 215, while in FIG. 2 AIoTF 205 interacts with AIoT RAN Node 215 via an AMF 207.

AIoT Inventory and AIoT Command are two AIoT service procedures supported in Release 19. AIoT Inventory service is used to obtain the target AIoT device's identifier, location and/or other information. AIoT command service is used to read data from, write data into, and/or disable, the target AIoT devices.

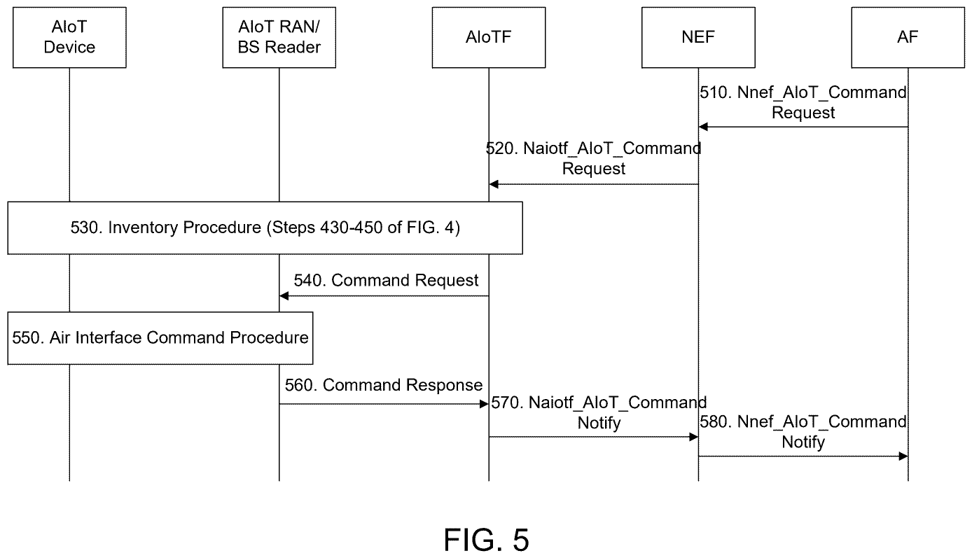

FIG. 4 illustrates an example signaling diagram of a high-level AIoT Inventory procedure, according to certain embodiments. As illustrated in the example of FIG. 4, at 410, the 5GC (e.g., NEF) may receive an AIoT Inventory request from the AF. An NF in the 5GC (e.g., the NEF) may select an AIoTF that can handle the service request and, at 420, may send the Inventory request to the AIoTF. The AIoTF may then select the AIoT RAN node or BS Readers that can reach the target AIoT devices and, at 430, may forward the service request to the AIoT RAN node and/or BS Reader(s). At 440, the AIoT RAN node and/or BS Readers then perform AIoT air interface procedures (e.g., AIoT paging and Random Access procedure) with the target AIoT device. If a response is received from the device, the AIoT RAN/BS Reader, at 450, forwards the response to the AIoTF which further forwards to the AF as shown at 460 and 470.

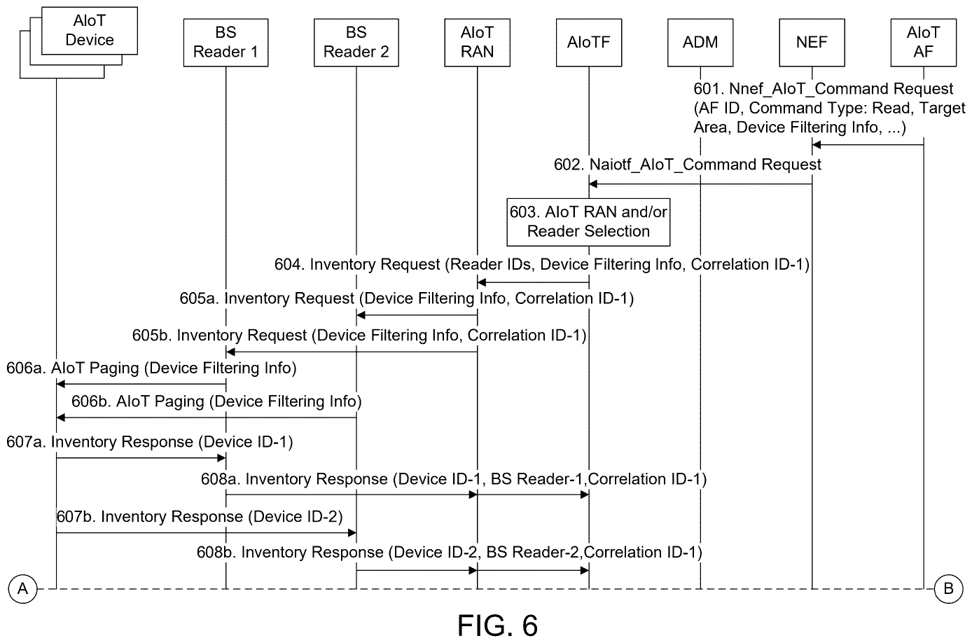

FIG. 5 illustrates an example signaling diagram of a high-level AIoT Command procedure, according to certain embodiments. As illustrated in the example of FIG. 5, at 510, the 5GC (e.g., NEF) may receive an AIoT Command request from the AF. At 520, the 5GC (e.g., NEF) may send the Command request to one or more selected AIoTF(s). As shown in the example of FIG. 5, at 530, the Inventory procedure may be performed first to make sure the target devices are available to execute the Command. After (e.g., only after) a positive Inventory response is received, then the Command procedure is further carried out in which, at 540, the AIoTF may send the Command request to the AIoT RAN and/or BS reader(s). At 550, the AIoT RAN and/or BS reader(s) may carry out an air interface Command procedure with the AIoT device. At 560, the AIoT RAN and/or BS reader(s) may send a Command response to the AIoTF, which forwards a Command notification to the AF as shown at 570 and 580.

An AIoT Command request received from the AF may target multiple AIoT devices (e.g., a group of AIoT devices). For example, device identification information included in the Command request may be or may include certain “filtering information” or “bitmask” that could point to a group of AIoT devices. In this case, when the AIoTF performs the Inventory procedure before executing Command request, the AIoTF may receive multiple Inventory responses from multiple AIoT devices that have received the Inventory request. Currently, in such a situation where multiple Inventory responses might be received from multiple devices, it is not clear how the 5GC can continue to carry out the Command procedure after the Inventory procedure. As such, some embodiments described herein provide procedures for addressing at least this issue, as well as other problems contemplated elsewhere herein.

As will be discussed in more detail below, an AIoTF (or similar network node) in the 5GC, may receive a Command request (e.g., from the AF or other network node) that is not targeted at a specific (e.g., one specific) AIoT device and/or is potentially associated with multiple AIoT target devices. In this case, the AIoTF may perform an AIoT Inventory procedure and may receive multiple device Inventory responses from multiple AIoT devices. According to certain embodiments, for a received device Inventory response (e.g., for each received device Inventory response), the AIoTF may construct a new Command request that is targeted at a specific AIoT device. For example, the new Command request may include the device identifier that has responded to the Inventory request. The AIoTF may send the Command request to the AIoT RAN and/or BS Readers.

In some embodiments, the AIoTF in the 5GC may receive, from an AF or other network node, an AIoT Command request that is not targeted at a specific AIoT device and/or potentially associated with multiple target devices. The AIoTF may first perform or initiate an AIoT Inventory procedure and may receive multiple device Inventory responses from multiple AIoT devices. The received device Inventory response may include the device identifier associated with the device sending the respective Inventory response. According to certain embodiments, for each received device Inventory response, the AIoTF may construct a new Command request that is targeted at a specific AIoT device. For example, the new Command request may include the device identifier that has responded to the Inventory request. The AIoTF may send the new Command request to the AIoT RAN and/or BS Reader(s). In an embodiment, for each new Command request, the AIoTF may also append the BS Reader information and/or a Correlation ID. In some embodiments, the content of the new Command request may be taken from the original Command request as received from the AF. According to an embodiment, the AIoTF may receive the individual Command responses from the multiple devices, aggregate them as a single Command report and send the report to the AF. The aggregated Command report may include the multiple device identifiers for the devices that have responded to the individual Command requests.

As introduced above, according to certain embodiments, when the 5GC receives a Command request from the AF, it performs the Inventory procedure first and carries out the Command request after the inventory response is received. In an embodiment, if the original Command request received from the AF is not associated with a specific AIoT device, e.g., there is no device identification information in the request or the device identification information in the request is associated with multiple AIoT devices, then the 5GC may receive multiple Inventory responses from the AIoT devices. The inventory response may include, for example, the protected device identifier (e.g., encrypted device identifier or temporary device identifier), and/or the information of the Reader that has received the device's Inventory response (e.g., Reader ID, location, etc.). In this case, it is proposed that the 5GC performs individual Command procedure for each AIoT device from which the Inventory response is received. The device identifier information and Reader information collected from the device's Inventory response may be used to carry out the individual Command procedure, with the content of the Command taken from the original Command request from the AF. In certain embodiments, an appropriate timer may be applied by the 5GC to process individualized Command procedures directed to individual AIoT devices upon receipt of the Inventory responses within the duration of such a timer. This timer may be common for a set of AIoT devices or individual per a given AIoT device.

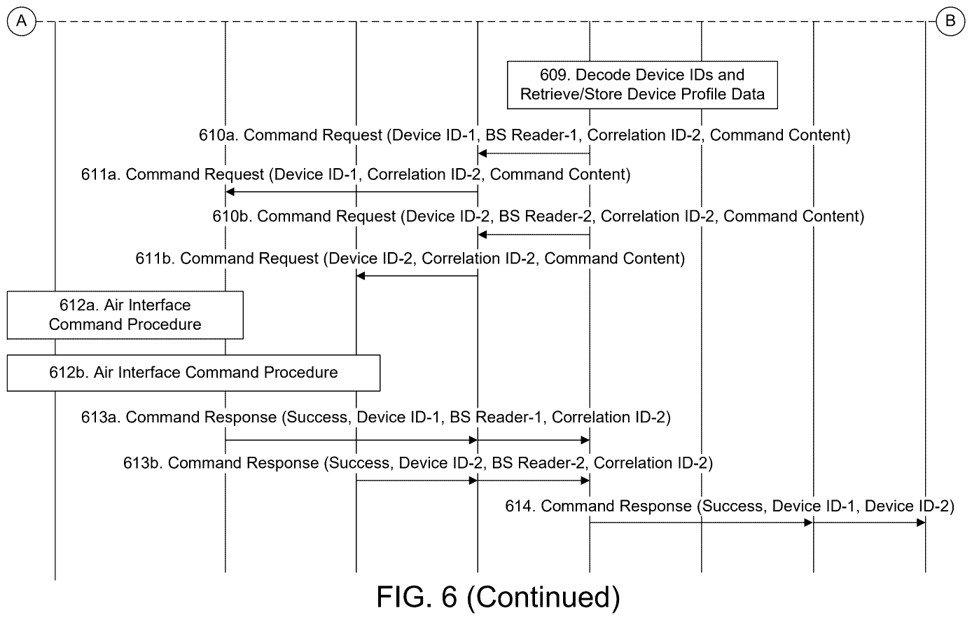

FIG. 6 illustrates a signaling diagram of a transformed Command procedure that may be performed after the Inventory procedure, according to some embodiments. As illustrated in the example of FIG. 6, at 601, the AIoT AF sends a Command Request to the 5GC (e.g., via NEF). The Command Request may include “device filtering information” that could be associated with multiple AIoT devices. The Command Request may also include target area information indicating where the target AIoT devices may be located. The Command Request may include the AF Identifier (AF ID) and/or type of the command to be executed, e.g., read data from, write data into, and/or disable.

In the example of FIG. 6, the NEF may select the AIoTF that can handle the Command request, e.g., based on target area information, and, at 602, may forward the Command request to the selected AIoTF.

As illustrated in the example of FIG. 6, the AIoTF may determine to perform Inventory procedure first. At 603, the AIoTF may select the AIoT RAN and/or BS Readers (e.g., BS Reader-1 and BS Reader 2) that may reach the target AIoT devices.

In the example of FIG. 6, At 604, the AIoTF may send an Inventory Request to the selected AIoT RAN. In the Inventory request, the AIoTF may include the “device filtering information” taken from the original Command request, and/or the selected BS Reader identifiers (e.g., IDs associated with BS Reader-1 and BS Reader-2). The AIoTF may also allocate a Correlation ID-1 that is used to link the device responses with the original service request and may include the Correlation ID-1 in the Inventory request.

As illustrated in the example of FIG. 6, at 605a and 605b, the AIoT RAN may forward the Inventory request to the selected BS Reader-1 and BS Reader-2. At 606a and 606b, BS Reader-1 and BS Reader-2 may broadcast AIoT Paging over the air interface. The paging message(s) may include the device filtering information. Multiple devices (e.g., Device ID-1 and Device ID-2) may find that the device filtering information in the AIoT Paging message matches its device identifier and send its response message to the Readers. The devices may include its encrypted device identifier or temporary identifier in the Inventory response message sent at 607a and 607b, respectively.

In the example of FIG. 6, at 608a and 608b, the AIoT RAN may forward the received device inventory responses to the AIoTF. The AIoT RAN may append the BS Reader identifier (that has received the device response) and the Correlation ID-1 for each device inventory response.

As illustrated in the example of FIG. 6, at 609, if the device identifier in the received device response is encrypted, the AIoTF may forward the encrypted device ID to the AIoT Data Management (ADM) which may be capable of decoding the device ID and return it to the AIoTF. Some information, such as the BS Reader ID that has received the device inventory response, may be stored as device profile data in the ADM. If the device identifier in the received device response is a temporary ID, the AIoTF may find the corresponding permanent device ID from the device context info stored in the AIoTF or from the device profile data stored in the ADM.

In the example of FIG. 6, at 610a and 610b, for each received device inventory response, the AIoTF may construct a Command Request message and send it to the AIoT RAN/BS Reader that has received the device inventory response. The Command Request may include a certain form of individual device identifier, which may be an encrypted device identifier or a temporary identifier. It is noted that the temporary identifier used in the new Command Request may be different from the one received in the device inventory response. The AIoTF may also allocate a new Correlation ID-2 for the Command Request. It is noted that the same Correlation ID-2 may be used for multiple Command Requests going to the multiple target devices that has responded to the inventory request. The AIoTF may append the BS Reader ID information (that has received the device inventory response) to the Command Requests. The content (e.g., read or write) of these new Command Requests may be taken from the original Command Request from the AF (as shown at 601).

Alternatively, if multiple device inventor responses are received by the same BS reader, the AIoTF may send a single Command request to the BS reader for those multiple devices, i.e., include the multiple device identifiers in the Command request.

As illustrated in the example of FIG. 6, at 611a and 611b, the AIoT RAN forwards the Command Requests to the BS Readers associated with the requests. At 612a and 612b, the BS Readers perform the air interface Command procedure with the target devices. At 613a and 613b, the BS Readers and/or the AIoT RAN forwards the received Command response which includes the device ID and Command execution result (e.g., success or not) to the AIoTF. Correlation ID-2 is appended to the Command response message. Similar to 609, if the received device ID in the Command response is encrypted or is a temporary ID, the AIoTF may interact with the ADM to retrieve the permanent device ID.

As shown in the example of FIG. 6, at 614, the AIoTF may aggregate the multiple individual Command responses from multiple devices as a single Command response (e.g., based on the common Correlation ID-2) or report corresponding to the original Command Request (as shown at 601). In the aggregated Command response or report message, multiple device IDs (e.g. permanent device IDs) that have responded to the Command request, and the Command execution result associated with each device, may be included.

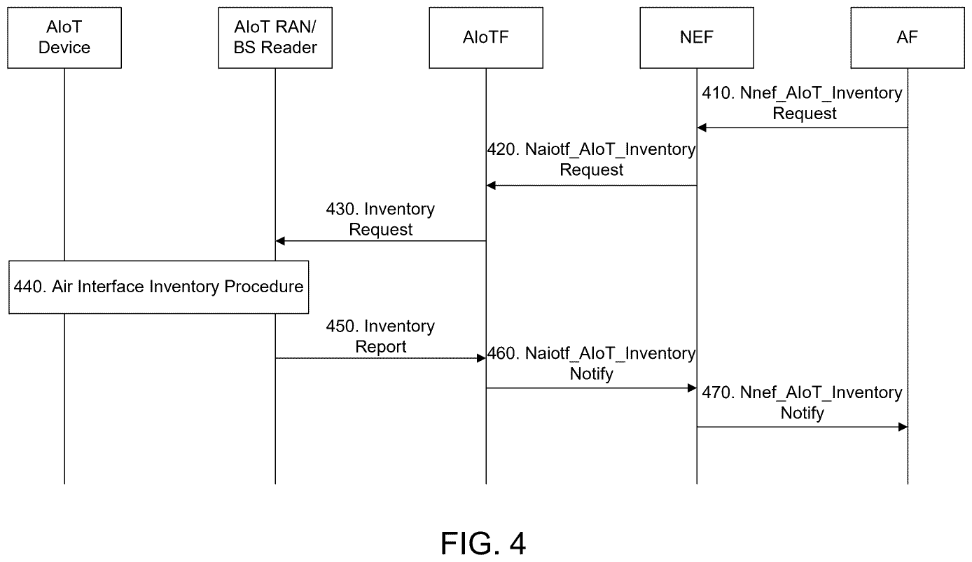

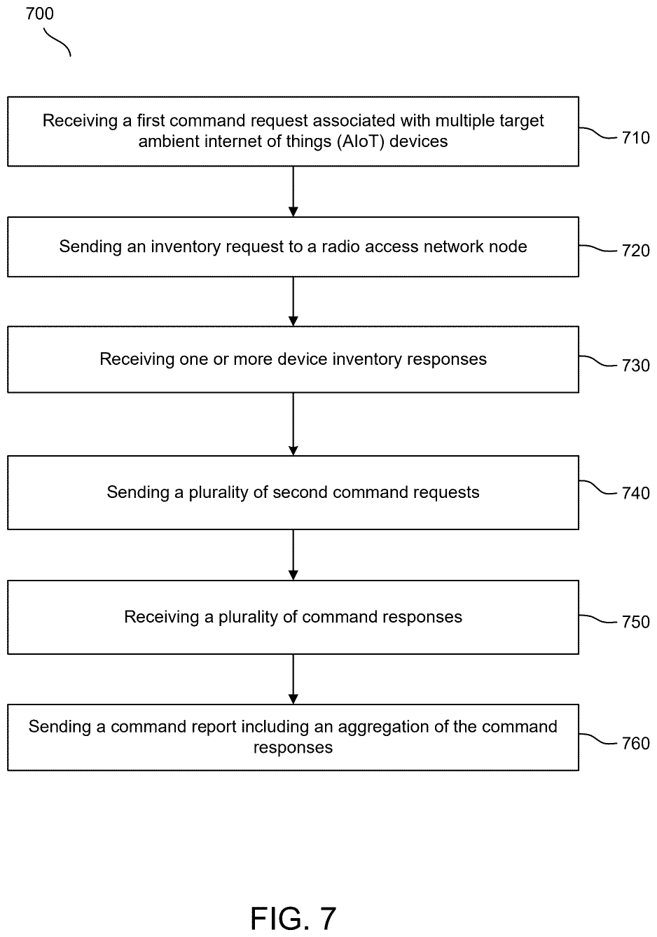

FIG. 7 illustrates an example flow diagram of a method 700 relating to handling ambient internet of things (AIoT) command procedures in a network, according to some example embodiments. The example method 700 of FIG. 7 and accompanying disclosures herein may include, may be based on, or may be a synthesization of various embodiments or elements discussed in detail above, such as those discussed with respect to FIGS. 2-6. For convenience and simplicity of exposition, the example of FIG. 7 may be described with reference to the architecture or system described above with respect to FIGS. 1A-1D, FIG. 2 and FIG. 3, for instance. However, the example method 700 depicted in FIG. 7 may be carried out using different architectures as well. According to some embodiments, the method 700 of FIG. 7 may be implemented by a network node or element, such as the AIoTF illustrated in any of FIGS. 2-6 (e.g., AIoTF 205 in FIGS. 2-3), or the like.

It is noted that the method 700 of FIG. 7 may include further steps, procedures or details as discussed in detail elsewhere in this disclosure. As such, the method 700 of FIG. 7 may be modified to include any of the steps, procedures, elements and/or details illustrated and/or discussed in the foregoing. Moreover, it is noted that the method and/or blocks of FIG. 7 may be modified to include, or to be replaced by, any one or more of the procedures, elements or blocks discussed elsewhere herein, such as in FIGS. 4-6. As such, one of ordinary skill in the art would understand that FIG. 7 is provided as one example and modifications thereto are possible while remaining within the scope of certain example embodiments as described herein.

As illustrated in the example of FIG. 7, the method 700 may include, at 710, receiving a first command request associated with multiple target ambient internet of things (AIoT) devices. At 720, the method 700 may include sending an inventory request to a RAN node (or to one or more BS readers, e.g., BS readers associated with or co-located with the RAN node).

As further illustrated in the example of FIG. 7, the method 700 may include, at 730, receiving one or more device inventory responses. The device inventory responses (e.g., each of the device inventory responses) may be associated with one of the target ambient internet of things (AIoT) devices. The device inventory responses (e.g., each of the device inventory responses) may indicate an identifier associated with a target ambient internet of things (AIoT) device from which the device inventory response is received. Based on the device inventory responses, the method 700 may include, at 740, sending a plurality of second command requests (e.g., two or more command requests). Each of the second command requests may be targeted for a respective target ambient internet of things (AIoT) device from the multiple target ambient internet of things (AIoT) devices. The second command requests (e.g., each of the second command requests) may indicate the respective identifier associated with the target ambient internet of things (AIoT) device from which the device inventory response is received.

As shown in the example of FIG. 7, the method 700 may include, at 750, receiving a plurality of command responses (e.g., two or more command responses). The command responses (e.g., each of the command responses) may be respectively associated with the respective target ambient internet of things (AIoT) device (e.g., associated with the target AIoT device(s) to which the second command requests were targeted) from the multiple target ambient internet of things (AIoT) devices. At 760, the method 700 may include sending a command report or response. The command report or response may include an aggregation of the command responses (e.g., an aggregation or combination of the information provided by the command responses), and may indicate a respective identifier associated with the multiple target ambient internet of things (AIoT) devices from which a command response was received (e.g., the command report or response may include an indication of the device ID for each of the target AIoT devices that provided a command response).

In an embodiment, the first command request may indicate any of: device filtering information, information indicating a target area where the target ambient internet of things (AIoT) devices are located, a type of command to be executed, and/or an identifier associated with an application function from which the first command request is received.

In an embodiment, the inventory request may indicate any of: information associated with device filtering, an identifier associated with one or more base station readers, and/or a first correlation identifier to associate the device inventory responses with the corresponding inventory request.

In an embodiment, the sending of a plurality of second command requests at 740 may include sending the second command requests to any of the RAN node and/or a BS reader (e.g., a BS reader associated with the RAN node).

In an embodiment, the method 700 may include selecting the RAN node to which the inventory request is sent, based on the RAN node's ability to reach one or more of the multiple target ambient internet of things (AIoT) devices (e.g., selecting the RAN node that has interface to one or more of the target AIoT devices).

In an embodiment, the second command requests may indicate any of: information associated with the base station reader, a second correlation identifier to associate the command responses with the corresponding command requests, and/or a type of command to be executed.

In an embodiment, the respective identifier associated with the target ambient internet of things (AIoT) device indicated in the second command requests may include any of: an encrypted device identifier or a temporary identifier.

In an embodiment, the command responses may respectively indicate any of: an identifier associated with the respective target ambient internet of things (AIoT) device from the multiple target ambient internet of things (AIoT) devices, an identifier associated with the base station reader from which the command response is received, and/or a correlation identifier to associate the command response with a corresponding command request.

In an embodiment, when the identifier associated with the respective target ambient internet of things (AIoT) device is encrypted, the method 700 may include forwarding the encrypted identifier associated with the respective target ambient internet of things (AIoT) device to a network node capable of decoding the encrypted identifier associated with the respective target ambient internet of things (AIoT) device. In an embodiment, when the identifier associated with the respective target ambient internet of things (AIoT) device is a temporary identifier, the method 700 may include obtaining a permanent identifier associated with the temporary identifier (e.g., obtaining or requesting the permanent identifier from another network node or otherwise looking up the permanent identifier).

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

### References

The following references may have been referred to hereinabove, each of which is incorporated herein by reference in its entirety.
3GPP draft TS 23.xyz V0.2.0, “Ambient power-enabled Internet of Things; Stage 2 (Release 19)”, 2025-02;
3GPP TR 23.700-13 V2.0.0, “Ambient power-enabled Internet of Things; (Release 19)”, 2025-02;
3GPP TR 38.769V19.0.0 , “Study on solutions for Ambient IoT (Internet of Things) in NR”, 2024-12.

1. A network element, comprising:
circuitry, including any of a processor and transceiver, configured to
receive a first command request associated with multiple target ambient internet of things (AIoT) devices;
send an inventory request to a radio access network node;
receive one or more device inventory responses, wherein each of the device inventory responses is associated with one of the target ambient internet of things (AIoT) devices, and wherein each of the device inventory responses indicates an identifier associated with a target ambient internet of things (AIoT) device from which the device inventory response is received;
based on the device inventory responses, send a plurality of second command requests, wherein each of the second command requests is targeted for a respective target ambient internet of things (AIoT) device from the multiple target ambient internet of things (AIoT) devices, wherein each of the second command requests indicates the respective identifier associated with the target ambient internet of things (AIoT) device from which the device inventory response is received;
receive a plurality of command responses, wherein each of the command responses is respectively associated with the respective target ambient internet of things (AIoT) device from the multiple target ambient internet of things (AIoT) devices; and
send a command report comprising an aggregation of the command responses, wherein the command report indicates a respective identifier associated with the multiple target ambient internet of things (AIoT) devices from which a command response was received.

2. The network element of claim 1, wherein the first command request indicates any of: device filtering information, information indicating a target area where the target ambient internet of things (AIoT) devices are located, a type of command to be executed, and an identifier associated with an application function from which the first command request is received.

3. The network element of claim 1, wherein the inventory request indicates any of: information associated with device filtering, an identifier associated with one or more base station readers, and a first correlation identifier to associate the device inventory responses with the corresponding inventory request.

4. The network element of claim 1, wherein the second command requests are sent to any of the radio access network node and a base station reader.

5. The network element of claim 1, configured to:
select the radio access network node to which the inventory request is sent, based on its ability to reach one or more of the multiple target ambient internet of things (AIoT) devices.

6. The network element of claim 1, wherein the second command requests indicate any of: information associated with the base station reader, a second correlation identifier to associate the command responses with the corresponding command requests, and a type of command to be executed.

7. The network element of claim 1, wherein the respective identifier associated with the target ambient internet of things (AIoT) device indicated in the second command requests comprises any of: an encrypted device identifier or a temporary identifier.

8. The network element of claim 1, wherein the command responses respectively indicate any of: an identifier associated with the respective target ambient internet of things (AIoT) device from the multiple target ambient internet of things (AIoT) devices, an identifier associated with the base station reader from which the command response is received, and a correlation identifier to associate the command response with a corresponding command request.

9. The network element of claim 8, configured to:
on condition that the identifier associated with the respective target ambient internet of things (AIoT) device is encrypted, forward the encrypted identifier associated with the respective target ambient internet of things (AIoT) device to a network node capable of decoding the encrypted identifier associated with the respective target ambient internet of things (AIoT) device; or
on condition that the identifier associated with the respective target ambient internet of things (AIoT) device is a temporary identifier, obtain a permanent identifier associated with the temporary identifier.

10. A method, implemented by a network element, the method comprising:
receiving a first command request associated with multiple target ambient internet of things (AIoT) devices;
sending an inventory request to a radio access network node;
receiving one or more device inventory responses, wherein each of the device inventory responses is associated with one of the target ambient internet of things (AIoT) devices, and wherein each of the device inventory responses indicates an identifier associated with a target ambient internet of things (AIoT) device from which the device inventory response is received;
based on the device inventory responses, sending a plurality of second command requests, wherein each of the second command requests is targeted for a respective target ambient internet of things (AIoT) device from the multiple target ambient internet of things (AIoT) devices, wherein each of the second command requests indicates the respective identifier associated with the target ambient internet of things (AIoT) device from which the device inventory response is received;
receiving a plurality of command responses, wherein each of the command responses is respectively associated with the respective target ambient internet of things (AIoT) device from the multiple target ambient internet of things (AIoT) devices; and
sending a command report comprising an aggregation of the command responses, wherein the command report indicates a respective identifier associated with the multiple target ambient internet of things (AIoT) devices from which a command response was received.

11. The method of claim 10, wherein the first command request indicates any of: device filtering information, information indicating a target area where the target ambient internet of things (AIoT) devices are located, a type of command to be executed, and an identifier associated with an application function from which the first command request is received.

12. The method of claim 10, wherein the inventory request indicates any of: information associated with device filtering, an identifier associated with one or more base station readers, and a first correlation identifier to associate the device inventory responses with the corresponding inventory request.

13. The method of claim 10, wherein the sending of a plurality of second command requests comprises sending the second command requests to any of the radio access network node and a base station reader.

14. The method of claim 10, comprising:
selecting the radio access network node to which the inventory request is sent, based on an ability of the radio access network node to reach one or more of the multiple target ambient internet of things (AIoT) devices.

15. The method of claim 10, wherein the second command requests indicate any of: information associated with the base station reader, a second correlation identifier to associate the command responses with the corresponding command requests, and a type of command to be executed.

16. The method of claim 10, wherein the respective identifier associated with the target ambient internet of things (AIoT) device indicated in the second command requests comprises any of: an encrypted device identifier or a temporary identifier.

17. The method of claim 10, wherein the command responses respectively indicate any of: an identifier associated with the respective target ambient internet of things (AIoT) device from the multiple target ambient internet of things (AIoT) devices, an identifier associated with the base station reader from which the command response is received, and a correlation identifier to associate the command response with a corresponding command request.

18. The method of claim 17, comprising:
on condition that the identifier associated with the respective target ambient internet of things (AIoT) device is encrypted, forwarding the encrypted identifier associated with the respective target ambient internet of things (AIoT) device to a network node capable of decoding the encrypted identifier associated with the respective target ambient internet of things (AIoT) device; or
on condition that the identifier associated with the respective target ambient internet of things (AIoT) device is a temporary identifier, obtaining a permanent identifier associated with the temporary identifier.
